(19) United States
(12) Patent Application Publication
(10) Pub. No.: US 2026/0095005 A1
(43) Pub. Date: Apr. 2, 2026

(54) ELECTRICITY CHARGING PORT OF VEHICLE

(71) Applicants: Hyundai Motor Company, Seoul (KR); Kia Corporation, Seoul (KR)

(72) Inventors: Ji Ho Lee, Hwaseong-si (KR); Sin Kook Kim, Hwaseong-si (KR)

(21) Appl. No.: 19/046,038

(22) Filed: Feb. 5, 2025

(30) Foreign Application Priority Data
Sep. 30, 2024 (KR) 10-2024-0133075

(51) Int. Cl. H01R 13/74; B60L 53/16; H01R 24/76

(52) U.S. Cl. CPC H01R 13/748; B60L 53/16; H01R 24/76

(57) ABSTRACT

An electricity charging port of a vehicle that may absorb tolerance when installed on a vehicle body is provided. The electricity charging port can include an inlet bracket mounted on an inner panel of a vehicle body and having a charging inlet, a housing mounted in an opening of an external panel coupled to the vehicle body and accommodating the charging inlet, and a mounting seat provided on the housing and coupled to the inlet bracket by a fastener, wherein the mounting seat includes an elastic material.

### CROSS-REFERENCE TO RELATED APPLICATIONS

This application claims benefit of priority to Korean Patent Application No. 10-2024-0133075 filed on Sep. 30, 2024 in the Korean Intellectual Property Office, the disclosure of which is incorporated herein by reference in its entirety.

### TECHNICAL FIELD

The present disclosure relates to an electricity charging port of a vehicle.

### BACKGROUND

As electric vehicles have been actively developed, the position of a charging port for charging batteries has been changed on vehicle bodies, unlike fuel ports of internal combustion engine vehicles. For example, charging ports may be disposed on a fender side connected to vehicle bodies.

In this case, an inlet to which a connector of a charger is connected is mounted on the vehicle body, and the charging port and the inlet are connected to each other by fasteners, such as nuts and bolts. Accordingly, to install the charging port, a gap between the vehicle body and the fender in a width direction has to be uniform.

However, because the fender is a component that needs to match a hood, door, side outer, etc., it may be difficult to maintain a constant gap between the vehicle body in which the inlet is installed and the fender in which the charging port is disposed.

### SUMMARY

The present disclosure relates to an electricity charging port of a vehicle that may absorb tolerance when installed on a vehicle body.

An embodiment of the present disclosure can provide an electricity charging port of a vehicle that may absorb tolerance when installed on a vehicle body.

According to an embodiment of the present disclosure, an electricity charging port can include: an inlet bracket mounted on an inner panel of a vehicle body and having a charging inlet; a housing mounted in an opening of an external panel coupled to the vehicle body and accommodating the charging inlet; and a mounting seat provided on the housing and coupled to the inlet bracket by a fastener, wherein the mounting seat includes an elastic material.

A coupling portion having a coupling hole formed therein may be provided on one side of the inlet bracket, and the coupling portion may be fixedly coupled to the mounting seat via the fastener.

The housing may include a through-hole, and the charging inlet may be positioned to be inserted into the through-hole from the outside of the housing and to protrude into the interior of the housing, and be positioned to correspond to the opening.

The housing may be integrally molded with an elastic sealing member and formed as a single member.

The housing may include a through-hole, and the sealing member may include: an outer sealing portion disposed along an outer end of the housing in a vehicle width direction; an inner sealing portion disposed along an inner edge of the through-hole; and at least one connecting portion connecting the outer sealing portion to the inner sealing portion.

The sealing member may be formed by double injection molding, and the mounting seat may be formed together with the sealing member.

The housing may include a connection hole, and the mounting seat may include a core portion connected to an inner edge of the connection hole and extending outwardly of the housing, a neck portion extending radially inwardly from an end of the core portion, a flat portion extending in a thickness direction of the neck portion from a radially inner end of the neck portion, and a metal ring joined to an inner circumferential surface of the flat portion.

The core portion, the neck portion, and the flat portion may be formed of an elastic material.

A tolerance absorption amount between the inner panel and the external panel may be adjustable according to an end shape of the core portion and a thickness of the neck portion.

When a gap between the inlet bracket and the housing is narrow, the end of the core portion may shrink and the neck portion may be deformed toward the housing.

When the gap between the inlet bracket and the housing is wide, the neck portion may be deformed toward the inlet bracket.

The inner panel and the external panel may be joined by bolting, the inlet bracket may be mounted in the inner panel by bolting, and the housing may be mounted in the opening via a clip.

### BRIEF DESCRIPTION OF THE DRAWINGS

The above and other features and advantages of the present disclosure can be more clearly understood from the following detailed description, taken in conjunction with the accompanying drawings, in which:

FIG. 1 is an exploded perspective view illustrating an example of an electricity charging port applied to a vehicle according to an embodiment of the present disclosure;

FIG. 2 is a perspective view illustrating an electricity charging port according to an embodiment of the present disclosure;

FIG. 3 is a bottom view of the electricity charging port of FIG. 2;

FIG. 4 is a cross-sectional view taken along line I-I of FIG. 3;

FIG. 5 is a partially cross-sectional view illustrating a state in which an electricity charging port is mounted on a vehicle body according to an embodiment of the present disclosure;

FIG. 6 is a diagram illustrating an operation of an electricity charging port absorbing tolerance when a gap is narrow according to an embodiment of the present disclosure; and

FIG. 7 is a diagram illustrating an operation of an electricity charging port absorbing tolerance when the gap is wide according to an embodiment of the present disclosure.

### DETAILED DESCRIPTION OF ILLUSTRATIVE EMBODIMENTS

Hereinafter, example embodiments of the present disclosure are described in detail through drawings. When adding reference numerals to components in each drawing, it can be noted that identical components can be given same reference numerals as much as possible although they can be shown in different drawings. Terms used in relation to direction can be defined based on a vehicle, i.e., an installation target.

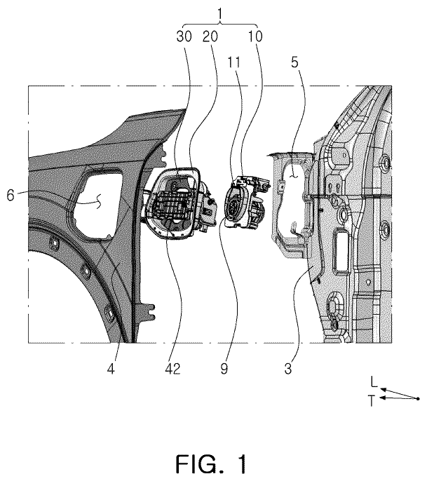

FIG. 1 is an exploded perspective view illustrating an example of an electricity charging port applied to a vehicle according to an embodiment of the present disclosure.

An electricity charging port 1 according to an embodiment of the present disclosure may include an inlet bracket 10, a housing 20, and a mounting seat 30.

The electricity charging port 1 according to an embodiment of the present disclosure may be applied to vehicles. Such vehicles can include, for example, an electric vehicle generating driving power with a motor, a plug-in hybrid vehicle generating driving power with at least one of an engine and a motor, or the like.

Such a vehicle may be configured to charge a driving battery (not shown) from charging facilities installed in various locations.

The vehicle may include an inner panel 3 forming a vehicle body and an external panel 4 coupled to the vehicle body. The inner panel may form a so-called “body in white.” The external panel may be configured as a fender or side outer and may include an opening 6 for installing an electricity charging port.

The external panel 4 configuring the fender may be connected to the inner panel 3 or the vehicle body, for example, by bolting or the like. It may be difficult to maintain a specified or desired gap between the vehicle body and the fender after assembly.

The inlet bracket 10 may be mounted on the inner panel 3 and may be provided with a charging inlet 9. The inlet bracket can be a roughly annular member fixed to the inner panel together with the charging inlet and may be formed separately from the charging inlet. The inlet bracket may be disposed to surround a connection terminal of the charging inlet and may be integrally coupled to the charging inlet.

For example, a mounting hole 5 may be formed in the inner panel 3, and an assembly in which the charging inlet 9 and the inlet bracket 10 are combined may be fixed to the mounting hole or a portion around the mounting hole, for example, by bolting, fastening, or fitting.

A coupling portion 11 for coupling with the housing 20 may be provided on one side of the inlet bracket 10. A coupling hole 12 for fastening a fastener 35 (see, e.g., FIG. 5), such as a bolt 36 and a nut 37, may be formed in the coupling portion.

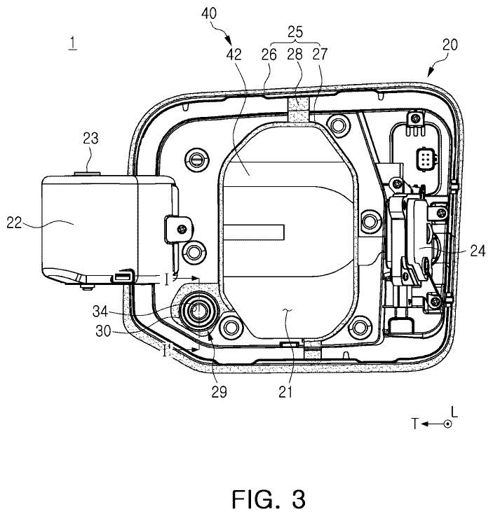

As described below, the coupling portion 11 of the inlet bracket 10 may be fixedly coupled to the mounting seat 30 (see, e.g., FIGS. 3 to 5) of the housing 20 via the fastener 35. Accordingly, the inlet bracket and the housing may be coupled to each other by bolting.

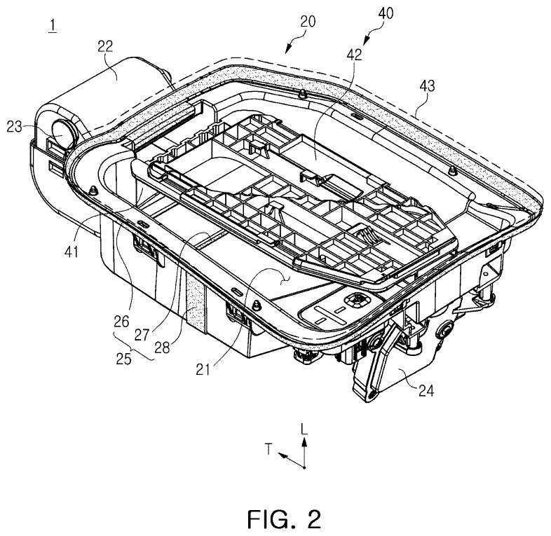

The charging inlet 9 can be a charging component having a connection terminal installed therein and may be accommodated in the housing through a through-hole 21 (see, e.g., FIGS. 2 and 3) of the housing 20. The charging inlet may be positioned to be inserted into the through-hole from the outside of the housing and to protrude toward the interior of the housing. In this case, a sealing member 25 (see, e.g., FIGS. 2 and 3) may be interposed between the inlet bracket 10 and the housing and/or between the charging inlet and the through-hole.

The charging inlet 9 can be fixed to the housing 20 via the inlet bracket 10 and may be positioned to correspond to the opening 6 of the external panel 4. A connection terminal may be exposed on one side of the charging inlet, and a wire connecting the connection terminal and the charging circuit of the vehicle may be connected on the other side.

In this manner, the connector disposed at the cable end of the charger may be connected to the connection terminal of the charging inlet 9 accommodated in the housing 20 through the opening 6 of the external panel 4. A battery (not shown) of the vehicle may receive power from the charger by connecting the connector and the charging inlet to be charged.

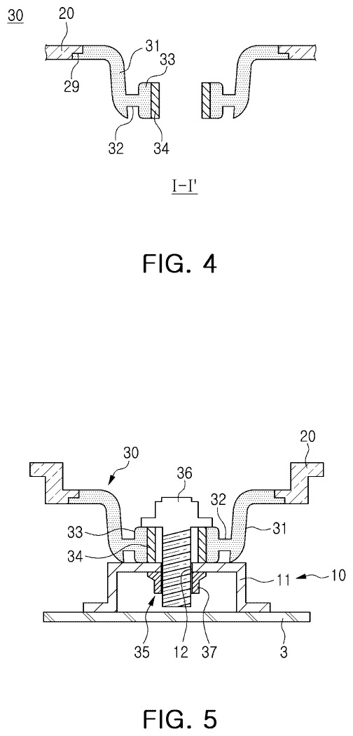

FIG. 2 is a perspective view illustrating an electricity charging port according to an embodiment of the present disclosure. FIG. 3 is a bottom view of the electricity charging port of FIG. 2. FIG. 4 is a cross-sectional view taken along line I-I of FIG. 3. FIG. 5 is a partially cross-sectional view illustrating a state in which an electricity charging port is mounted on a vehicle body according to an embodiment of the present disclosure;

The housing 20 can be a roughly cylindrical member installed inwardly in a vehicle width direction L from the edge of the opening 6 formed in the external panel 4 and may be fastened to the external panel from the interior of the vehicle by use of a clip or the like.

A cross-sectional shape of the outer end of the housing 20 in the vehicle width direction L may correspond to the opening 6. For example, the cross-sectional shape may be a square shape with round corners, but is not necessarily limited thereto, and may be a circular, oval, or any polygonal shape.

A through-hole 21 having a predetermined shape surrounding the charging inlet 9 may be formed on the inner bottom of the housing 20 in the vehicle width direction L and the charging inlet may be positioned to protrude into the housing through the through-hole.

In this manner, the housing 20 can be fitted into the opening 6 of the external panel 4 and can be mounted to surround the charging inlet 9 from the external panel toward the inner panel 3, so that the housing may constitute a sidewall of the electricity charging port 1.

The electricity charging port 1 according to an embodiment of the present disclosure may further include a door 40. The door may include a hinge connecting portion 41, a door support 42, and a door plate 43.

To open and close the door 40, a hinge portion 22 may be provided on one side of the housing 20, for example, one side of the vehicle in a length direction T.

The hinge connecting portion 41 may be rotatably connected to the hinge portion 22 of the housing 20 by a hinge pin 23.

The door support 42 may extend linearly from an end of the hinge connecting portion 41 to be integrally formed. Thus, the door support may rotate together with the rotation of the hinge connecting portion.

The door plate 43 can be a cover located on the outer surface of the door support 42 and may have a cross-sectional shape and size (e.g., area) corresponding to the housing 20 to open and close the housing.

The door 40 configured in this manner may at least partially open or close the opening 6 of the external panel 4 by rotating between a position for opening the housing 20 and a position for closing the housing. When the door is opened, the connection terminal of the charging inlet 9 inside the housing becomes visible from the outside of the vehicle, thereby enabling connection of the connector.

Selectively, in the electricity charging port 1 according to an embodiment of the present disclosure, the housing 20 may further be provided with a push switch 24 on the opposite side of the hinge portion 22. A locking groove (not shown) corresponding to the push switch may be formed on the opposite side of the door plate 43 at the end of the door support 42.

When a user applies a predetermined force to a position corresponding to the push switch 24 on the door plate 43 of the door 40, the connection between the locking groove and the push switch 24 may be released and the door plate pops up at a certain angle to be opened. Thereafter, the user may easily open the door completely.

The method of controlling the opening and closing of the door 40 with the push switch 24 is merely an example, and the present disclosure is not necessarily limited thereto.

In the electricity charging port 1 according to an embodiment of the present disclosure, the housing 20 may be formed integrally with the elastic sealing member 25. In other words, the housing may be formed as a single member by joining different materials.

For example, the sealing member 25 may be formed in a substantially integral frame shape. The frame-shaped sealing member may include: an outer sealing portion 26 disposed along an outer end of the housing 20 in the vehicle width direction L; an inner sealing portion 27 disposed along an inner edge of the through-hole 21; and at least one connecting portion 28 connecting the outer sealing portion to the inner sealing portion.

The sealing member 25 may be formed integrally with the housing 20 by double injection molding. For example, the housing may be molded from plastic, such as polypropylene (PP), and the sealing member may be molded from plastic, such as thermoplastic elastomer (TPE), or rubber.

The mounting seat 30 may be provided on the housing 20 and may be coupled to the inlet bracket 10 by a fastener 35. More specifically, the mounting seat formed in a connection hole 29 of the housing may be fixed to the coupling portion 11 of the inlet bracket 10 by a fastener 35, such as a bolt 36 and a nut 37, so that the assembly of the charging inlet 9 and the inlet bracket may be coupled to the housing and form the electricity charging port 1.

As shown in FIGS. 4 and 5, the mounting seat 30 may include: a core portion 31 connected to an inner edge of the connection hole 29 of the housing 20 and extending outwardly from the housing; a neck portion 32 extending radially inwardly from an end of the core portion; a flat portion 33 extending in a thickness direction of the neck portion from a radially inner end of the neck portion; and a metal ring 34 joined to an inner circumferential surface of the flat portion.

The core portion 31, the neck portion 32, and the flat portion 33 of the mounting seat 30 may be formed together when the sealing member 25 is formed integrally with the housing 20 by double injection molding. Accordingly, the core portion 31, the neck portion 32, and the flat portion 33 may be formed of plastic, such as a thermoplastic elastomer, or rubber like the sealing member 25, i.e., an elastic material.

The core portion 31 may form a tubular sidewall that secures height in the mounting seat 30 and guarantees overall rigidity. The neck portion 32 may substantially perform the role of absorbing tolerance between the housing 20 and the inlet bracket 10. The mounting seat may adjust the tolerance absorption amount between the inner panel 3 and the external panel 4 according to an end shape of the core portion and a thickness dimension of the neck portion.

The metal ring 34 may be formed of a solid metal, such as steel, for example, and the bolt 36 of the fastener 35 may penetrate the metal ring and be fastened to the nut 37. This can prevent the mounting seat from warping and allows fastening torque to be applied sufficiently when the fastener 35 is fastened to the mounting seat 30.

For example, fastening by the fastener 35, such as the bolt 36 and the nut 37, is one of the methods to increase the rigidity of the joint between two components. In this example, the seat of each component can be solid to increase the rigidity.

If one of the two components has a seat with weak rigidity, the corresponding component may be biased toward the opposite component, that is, the component with the strong seat. Therefore, if the seat is formed of a flexible material compared to the existing material, such as metal or reinforced plastic, the seat may move and absorb the tolerance.

Therefore, in the electricity charging port 1 according to an embodiment of the present disclosure, the mounting seat 30 provided on the housing 20 can be formed of an elastic material, so that when mounted by the fastener 35, the tolerance between the inlet bracket 10 and the housing 20, and even the tolerance between the inner panel 3 and the external panel 4 may be absorbed (e.g., compensated for by permitted elastic movement and deformation of the neck 32). In other words, the tolerance between the vehicle body and the fender may be absorbed.

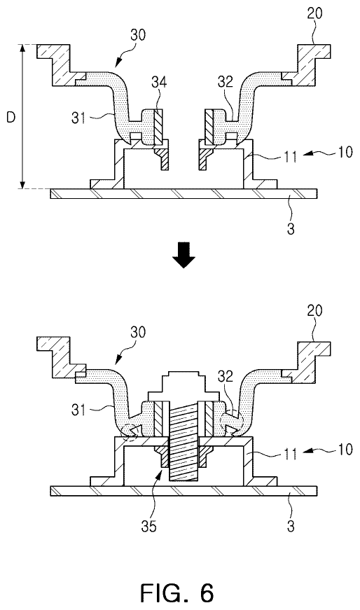

FIG. 6 is a diagram illustrating an operation of an electricity charging port absorbing tolerance when a gap is relatively narrow according to an embodiment of the present disclosure.

As illustrated in FIG. 6, when a gap D between the inlet bracket 10 and the housing 20 is relatively narrow, the mounting seat 30 may be folded at least partially.

For example, in the mounting seat 30, the end of the core portion 31 may shrink and the neck portion 32 may be deformed outwardly in the vehicle width direction L, i.e., toward the housing 20, so that the fastener 35 may be fastened to the mounting seat and the tolerance between the inlet bracket 10 and the housing 20 may be absorbed, and thus, both sides may be firmly fixed and coupled.

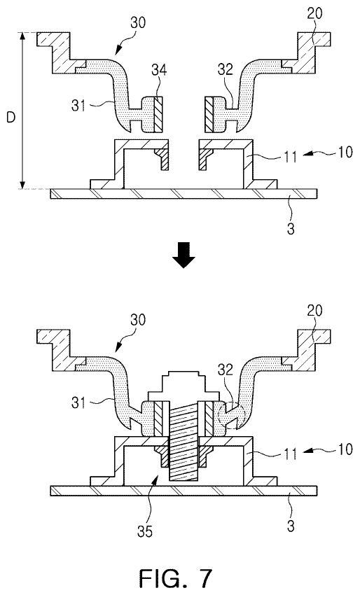

FIG. 7 is a diagram illustrating an operation of an electricity charging port absorbing tolerance when the gap is relatively wide according to an embodiment of the present disclosure.

As illustrated in FIG. 7, when the gap D between the inlet bracket 10 and the housing 20 is relatively wide, the mounting seat 30 may be at least partially elongated.

For example, in the mounting seat 30, the neck portion 32 may be deformed inwardly in the vehicle width direction L, that is, toward the inlet bracket 10, so that the fastener 35 may be fastened to the mounting seat and the tolerance between the inlet bracket 10 and the housing 20 may be absorbed, so that both sides may be firmly fixed and coupled.

As described above, in the electricity charging port according to an embodiment of the present disclosure, when mounted on the vehicle body, only the mounting seat provided in the housing may match the inlet bracket and the mounting seat may be deformable, so that the tolerance may be sufficiently absorbed, thereby increasing the degree of freedom in assembly and improving the assemblability and quality of the vehicle.

The description is merely illustrative of example embodiments of the present disclosure, and various modifications and changes may be made by those skilled in the art without departing from the scopes of the present disclosure.

Accordingly, the example embodiments disclosed in the present disclosure and the accompanying drawings are not intended to necessarily limit the present disclosure but to describe the present disclosure through examples, and the scopes of the present disclosure are not necessarily limited by the example embodiments and the accompanying drawings. The protection scopes of the present disclosure can be interpreted by the following claims, and all technical ideas within the equivalent scopes can be interpreted as being included in the scopes of the present disclosure.

What is claimed is:

1. An electricity charging port comprising:
an inlet bracket mounted on an inner panel of a vehicle body and having a charging inlet;
a housing mounted in an opening of an external panel coupled to the vehicle body and accommodating the charging inlet; and
a mounting seat provided on the housing and coupled to the inlet bracket by a fastener,
wherein the mounting seat includes an elastic material.

2. The electricity charging port of claim 1, wherein a coupling portion having a coupling hole therein is provided on one side of the inlet bracket, and the coupling portion is fixedly coupled to the mounting seat via the fastener.

3. The electricity charging port of claim 1, wherein the housing includes a through-hole, and the charging inlet is positioned to be inserted into the through-hole from outside of the housing and to protrude into an interior of the housing, and positioned to correspond to the opening.

4. The electricity charging port of claim 1, wherein the housing is integrally molded with an elastic sealing member and formed as a single member.

5. The electricity charging port of claim 4, wherein the housing includes a through-hole, and wherein the elastic sealing member comprises:
an outer sealing portion disposed along an outer end of the housing in a vehicle width direction,
an inner sealing portion disposed along an inner edge of the through-hole, and
at least one connecting portion connecting the outer sealing portion to the inner sealing portion.

6. The electricity charging port of claim 4, wherein the elastic sealing member is formed by double injection molding, and the mounting seat is formed together with the elastic sealing member.

7. The electricity charging port of claim 1, wherein the housing includes a connection hole, and wherein the mounting seat comprises:
a core portion connected to an inner edge of the connection hole and extending outwardly of the housing,
a neck portion extending radially inwardly from an end of the core portion,
a flat portion extending in a thickness direction of the neck portion from a radially inner end of the neck portion, and
a metal ring joined to an inner circumferential surface of the flat portion.

8. The electricity charging port of claim 7, wherein the core portion, the neck portion, and the flat portion are formed of the elastic material.

9. The electricity charging port of claim 7, wherein a tolerance absorption amount between the inner panel and the external panel is adjustable according to an end shape of the core portion and a thickness of the neck portion.

10. The electricity charging port of claim 9, wherein the mounting seat is configured such that, in response to a gap between the inlet bracket and the housing being decreased, the end of the core portion shrinks and the neck portion is deformed toward the housing.

11. The electricity charging port of claim 9, wherein the mounting seat is configured such that, in response a gap between the inlet bracket and the housing being increased, the neck portion is deformed toward the inlet bracket.

12. The electricity charging port of claim 1, wherein the inner panel and the external panel are joined by bolting,
wherein the inlet bracket is mounted in the inner panel by bolting, and
wherein the housing is mounted in the opening via a clip.

13. An electricity charging port for a vehicle, the electricity charging port comprising:
an inlet bracket configured to be mounted on an inner panel of a vehicle body of the vehicle;
a charging inlet attached to the inlet bracket;
a housing including an opening accommodating the charging inlet, wherein the housing is configured to engage with an external panel of the vehicle while the external panel is fixed to the vehicle body; and
a mounting seat comprising an elastic neck portion, wherein the mounting seat flexibly couples the housing to the inlet bracket via the elastic neck portion in a configuration such that a mounting distance between the housing relative to the inlet bracket can be varied via the elastic neck portion.

14. The electricity charging port of claim 13, wherein the mounting seat further comprises:
a core portion connected to an inner edge of a connection hole of the housing and extending in a first direction from the housing, wherein the elastic neck portion extends radially inwardly from an end of the core portion in a second direction, wherein the second direction intersects with the first direction;
a flat portion extending in a thickness direction of the elastic neck portion from a radially inner end of the elastic neck portion; and
a metal ring joined to an inner circumferential surface of the flat portion.

15. The electricity charging port of claim 14, further comprising a fastener, wherein the fastener comprises
a bolt extending through the metal ring and securing the metal ring; and
a nut threadedly engaged with the bolt, such that the fastener fixes the metal ring to the inlet bracket.

16. The electricity charging port of claim 14, wherein the core portion, the elastic neck portion, and the flat portion are formed of an elastic material.

17. The electricity charging port of claim 14, wherein a tolerance absorption amount between the inner panel and the external panel is adjustable according to an end shape of the core portion and a thickness of the elastic neck portion.
